(19) United States
(12) Patent Application Publication
(10) Pub. No.: US 2026/0138309 A1
(43) Pub. Date: May 21, 2026

(54) RECYCLING OF MATERIAL RESIDUE

(71) Applicant: BASF SE, Ludwigshafen am Rhein (DE)

(72) Inventors: Thomas KICIAK, Ludwigshafen am Rhein (DE); Andrea DECKER, Ludwigshafen am Rhein (DE); Klaus RIES, Ludwigshafen am Rhein (DE); Gregor HAVERKEMPER, Ludwigshafen am Rhein (DE); Matthias Frithjof HOEFFKEN, Ludwigshafen am Rhein (DE); Marcel Dominik KLEIN, Ludwigshafen am Rhein (DE)

(21) Appl. No.: 19/120,262

(22) PCT Filed: Oct. 6, 2023
(86) PCT No.: PCT/EP2023/077709

§ 371 Date: Apr. 11, 2025

(30) Foreign Application Priority Data
Oct. 13, 2022 (EP) 22201293.2
Dec. 19, 2022 (EP) 22000262.0
Jul. 6, 2023 (EP) 23183812.9

(51) Int. Cl. B29B 17/02; B29B 17/00

(52) U.S. Cl. CPC B29B 17/02; B29B 2017/0089; B29B 2017/0203; B29B 2017/0282

(57) ABSTRACT

Disclosed is a method for recycling of material residue from a material containing one or more synthetic polymer(s): providing one or more physical material identifier(s) and material data associated with ma-terial containing synthetic polymer(s); providing one or more receptable identifier(s) associated with a receptable for collecting the material residue from the material containing synthetic polymer(s); generating one or more recycling instruction(s) based on the receptable identifier(s) and the material data; providing the generated recycling instructions for recycling of the material residue. Disclosed are further methods, apparatuses, uses, computer programs and computer-readable media.

### TECHNICAL FIELD

The present disclosure relates to a method for recycling material residue from a material containing synthetic polymers. The present disclosure includes related methods, apparatuses, computer programs and computer-readable media.

### TECHNICAL BACKGROUND

In the use of polymeric materials such as foams scrape material is often disposed. Valuable material is hence lost or must be recycled in a costly manner. To recycle such scrape materials, in particular polystyrene-based foams used to insulate buildings and packaging, the process of collecting scrape material needs to be simplified.

WO2013184126A1 discloses methods, systems, and apparatuses, including computer programs encoded on computer-readable media, for scanning a barcode on an article to obtain article recycling information. A first incentive is received based upon the scanning of the article and a second incentive is received based upon verification that the article was recycled.

EP3716174A1 discloses a method for tracing a food package for assuring efficient recycling is provided. The method comprises establishing a first communication session between the food package and a user device, receiving a user identification associated to the user device, receiving a package identification from a package identification device provided in the food package, establishing a second communication session between the food package and a package collecting device, receiving a PCD identification from the package collecting device, determining package material associated with the food package by using the package identification, determining recycling material associated with the package collecting device by using the PCD identification, in case the package material and the recycling material match, in case a package disposal is detected by the package collecting device, registering a recycling confirmation to a user account associated with the user identification.

### SUMMARY OF THE INVENTION

Disclosed is an apparatus for recycling material residue from a material containing one or more synthetic polymer(s):
a material provider interface configured to provide a physical material identifier and material data associated with the material containing the synthetic polymer(s), e.g. the material residue from the material containing synthetic polymers
a receptable provider interface configured to provide a receptable identifier associated with a receptable for collecting the material residue from the material containing synthetic polymer(s);
a recycling instruction generator configured to generate one or more recycling instruction(s) based on the receptable identifier and the material data;
an output interface configured to provide the generated recycling instruction(s) for recycling of the material residue.

Disclosed is a method for recycling material residue from a material containing one or more synthetic polymer(s):
providing a physical material identifier and material data associated with the material containing the synthetic polymer(s), e.g. material residue from the material containing synthetic polymer(s),
providing a receptable identifier associated with a receptable for collecting the material residue from the material containing synthetic polymer(s);
generating one or more recycling instruction(s) based on the receptable identifier and the material data;
providing the generated recycling instruction(s) for recycling of the material residue.

Disclosed is an apparatus for recycling of material residue from a material containing one or more synthetic polymer(s):
a material provider interface configured to provide one or more physical material identifier(s) and material data associated with the material containing synthetic polymer(s), preferably wherein material data is accessed via the one or more physical material identifier(s), preferably wherein the material data relates to the material the material residue is produced from;
a receptable provider interface configured to provide one or more receptable identifier(s) associated with receptable(s) for collecting material residue from the material containing synthetic polymer(s);
a recycling instruction generator configured to generate one or more recycling instruction(s) based on the one or more receptable identifier(s) and the material data;
an output interface configured to provide the generated recycling instruction(s) for recycling of the material residue.

Disclosed is a method for recycling of material residue from a material containing one or more synthetic polymer(s):
providing one or more physical material identifier(s) and material data associated with the material containing synthetic polymer(s), preferably wherein material data is accessed via the one or more physical material identifier(s), preferably wherein the material data relates to the material the material residue is produced from;
providing one or more receptable identifier(s) associated with receptable(s) for collecting the material residue from the material containing synthetic polymer(s);
generating one or more recycling instruction(s) based on the one or more receptable identifier(s) and the material data;
providing the generated recycling instruction(s) for recycling of the material residue.

Disclosed is a computer-readable medium or a computer program with instructions, which when executed on a processor or a computing node, perform the steps of the methods disclose herein. A computer-readable medium or a computer program with instructions, which when executed on a processor, perform the steps as provided by the apparatus disclosed herein.

Disclosed is the use of the recycling instruction(s) generated according to any of the methods disclosed herein for recycling a material residue from material containing one or more synthetic polymer(s). Use of the recycling instructions generated by any of the apparatuses disclosed herein for recycling a material residue from material containing one or more synthetic polymer(s).

Disclosed is a method for using recycling instruction(s) generated according to any of the methods disclosed herein to recycle a material residue from material containing one or more synthetic polymer(s). A method for using recycling instruction(s) generated by any of the apparatuses disclosed herein to recycle a material residue from material containing one or more synthetic polymer(s).

### EMBODIMENTS

Any disclosure and embodiments described herein relate to the methods, the apparatuses, the systems, and the computer program elements lined out herein and vice versa. Advantageously, the benefits provided by any of the embodiments and examples equally apply to all other embodiments and examples and vice versa.

As used herein “determining” also includes “initiating or causing to determine”, “querying, accessing, correlating” also includes “initiating or causing to query, access, correlate” and “providing” also includes “initiating or causing to determine, generate, select, send or receive”. “Initiating or causing to perform an action” includes any processing signal that triggers a computing device to perform the respective action.

The methods, apparatuses, systems and computer elements disclosed herein provide an efficient, secure and robust way for sharing or exchanging data between different participants of the material chain, e.g. producer, user and/or recycler of the material. In particular, by making the material data available on the collection of material residue or scrape material into a receptable, the recycling can be processed in a more reliable, safer and cost-effective manner than known to date.

Recycling of material residue is particularly challenging, since the material composition, manufacturer or the like cannot be easily tracked for material residue. In particular any identification element associated with the intact material are lost for the material residue. The use of receptable identifier associated with a receptable for collecting material residue and the material data accessed via the physical material identifier(s) for generating one or more recycling instruction(s) allows to overcome such difficulty.

In an embodiment, the material residue includes residues resulting during production of the material containing the at least one synthetic polymer, residues resulting from the use of said material and/or residues resulting from the use of a component produced based on or from said material. Material residue may be residues resulting during production of the material containing the at least one synthetic polymer, residues resulting from the use of said material or residues resulting from the use of a component produced from or based on said material. For instance, residues may be production residues, such as residues of material remaining within the apparatus used to produce the material containing the at least one synthetic polymer. In another instance, residues may be produced during use of the material, for example during production of a component or use of a component produced from or based on said material. Said residues produced during production of a component or use of the component containing the material may be scrap material. Scrap material may be produced during cutting the material or the component containing the material e.g. to a required form and/or size. Material residue may relate to pre- or post-consumer residue. The material containing one or more synthetic polymer(s) may refer to different material types(s) containing one or more synthetic polymer(s). The material containing one or more synthetic polymer(s) may include material produced by different material producer(s).

In another embodiment, the synthetic polymer may be a chemical compound which is produced by a chemical production from one or more starting material(s), such as monomers, and which comprises at least two monomer units. The monomer units may be regarded as subunits of the polymer. The polymer may be prepared from the monomers by commonly known polymerization reactions. The polymer may be produced from a single type of monomers or from different monomers. The monomer units may be distributed randomly or may be present as blocks within the polymer. The polymer may be a linear polymer. The polymer may be a branched polymer.

The polymer may be a crosslinked polymer. The synthetic polymer may be used to produce material containing the synthetic polymer. The material may be used to produce a component.

The material may be embodied in a discrete component, such as packaging of the material. The component may be produced from the material. The component may contain the material. The component may be an insulation board. The component may be used for different applications, e.g. for insulation. The component may be used to produce a product. Any reference to material may include the reference to the component embodying the materials, the component produced from the material or the component containing the material. The component may refer to a discrete unit, such as a package of the material, a components produced from or containing the material, a batch of components produced from or containing the material or combinations thereof.

In one embodiment the material data is associated with the material the material residue is produced from. The material data may be accessed or accessible via or through the one or more physical material identifier(s). The material data associated with the one or more physical material identifier(s) may be provided by a producer of the material, e.g. on production of the material. The physical material identifier may be uniquely associated with a producer and/or material data associated with the material. The physical material identifier may be uniquely associated with the physical entity of the material. The physical material identifier may be uniquely associated with an individual entity of the material. The physical entity or individual entity may comprise one or more component(s) containing the material or produced based on or from the material. The physical material identifier may thus allow to tracking of material residues from the material. For instance, the material identifier may be uniquely associated with the material entity such as a thermal insulation panel or packaging material. The physical material identifier may by a digital identifier uniquely associated with the physical entity of the material. Physical in this context refers to the digital identification of the physical entity of the material. The material identifier and physical material identifier may be used interchangeably.

The material identifier may be part of a material passport provided to a central or decentral network. The material identifier may be provided to the central or decentral network and associated with the material data. The material identifier may be provided to the central or decentral network and associated with a public key for accessing the material data. The material identifier may be provided to the central or decentral network and associated with an authentication mechanism, such as a public key, for accessing the material data. The material identifier may be provided to the central or decentral network and associated with a representation of the material data, such as a link or pointer to the material data. The material passport may include the material identifier, the representation of or linking to the material data and/or the authentication mechanism for accessing the material data.

The material identifier may be uniquely associated with a producer and/or material data associated with the material at the time of production of the material. At the time of production of the material may include any point leading to production of the material. At the time of production of the material may include on production of the material, on providing the material to be used or at production of the material. By providing the physical material identifier on production the material can be traced.

In another embodiment the material data is accessed via the one or more physical material identifier(s). The material data associated with the physical material identifier may be accessed prior to or on recycling of the material residue. The material data may be accessed or provided prior to use of the material leading to the material residue or after use of the material leading to the material residue, e.g. if the identifier element providing the physical material identifiers was attached to the packaging of the material, while the identifier element is still intact. In addition, the receptable identifier(s) may be provided. The receptable identifier(s) may be associated with the receptable(s) to be filled with the material residue stemming from the material the material data is provided for. This way the material data may specify the material residue content of the receptable.

The material data may be accessed based on the authentication mechanism, such as the public key provided to the central or decentral network. The material data may be stored in a data base of a central computing system and may be accessed by a user apparatus associated with the user of the material and/or a recycling apparatus associated with the recycler of the material via the authentication mechanism. The material data may be stored in a data base associated with the producer. The material data may be accessed by a user apparatus associated with the user of the material and/or a recycling apparatus associated with the recycler of the material via the authentication mechanism. The authentication mechanism may be based on a private key and a public key associated with or connected to the physical material identifier.

Prior to recycling may include any point in time between providing the material for use and recycling the scrape or residue. Prior to recycling may include any point in time between providing the material for use and collecting the scrape or residue. Prior to recycling may include any point in time between providing the material for use and collecting the scrape or residue in a receptable. On recycling may include any point in time when scrape or residue incurs. By providing the physical material identifier on production, the material data of the manufacturer can be safely accessed on recycling and used for recycling. This way the material data can be efficiently used to operate the recycling process.

In another embodiment the material data includes chemical composition data of the material and/or manufacturing data of the material. Material data may include the trade name of the material, the chemical composition of the material and/or the manufacturing specifics of the material. The material data like chemical composition data of the material, manufacturing data of the material and/or the application data of the material may be used to generate the recycling instructions that relate to a physical filling of receptables with material residue, a physical collection of filled receptables, a physical sorting of filled receptables and/or a physical recycling of the material residue provided by a recycling plant. Physical recycling refers to any recycling process or plant such as mechanical or chemical recycling process or plant. For instance, the chemical composition may be used to generate recycling instructions for physical filling of receptables with material residue, physical collection of filled receptables, physical sorting of filled receptables and/or physical recycling of the material residue provided by a recycling plant. This way the recyclate composition can be controlled by controlling the material residue stream into recycling plants along the material use cycle. Further for instance, the manufacturing data, such as manufacturer, manufacturing method or educts used for manufacturing, may be used to generate recycling instructions for physical filling of receptables with material residue, physical collection of filled receptables, physical sorting of filled receptables and/or physical recycling of the material residue provided by a recycling plant. Further for instance, the application data, such as use of the material in a specific application, may be used to generate recycling instructions for physical filling of receptables with material residue, physical collection of filled receptables, physical sorting of filled receptables and/or physical recycling of the material residue provided by a recycling plant. This way the recyclate composition can be controlled by controlling the material residue stream into recycling plants along the material use cycle.

In another embodiment a material identifier element is connected to the material, wherein at least the physical material identifier is encoded in, to or on the material identifier element. In another embodiment the material identifier element is physically connected to the material. The identifier element may be physically attached to the material or the component. The identifier element may be physically attached to the packaging of multiple materials or components. The physical material identifier in the digital world may be linked to the material entity in the real world. The physical material identifier may be the digital twin associated with the physical entity of the material. This way the virtual or digital identifier of the material may be uniquely linked to the physical entity of the material. Such linking may include a physical link of identifiers uniquely associated with the physical entity of the material. For physical linking a tag or code may be physically connected to the material, e.g., by printing a QR code or an RFID tag or using other sensors or methods.

In another embodiment a receptable identifier element is connected to the receptable, wherein at least the receptable identifier is encoded in, to or on the receptable identifier element. In another embodiment the receptable identifier element is physically connected to the receptable.

The physical receptable identifier in the digital world may be linked to the receptable in the real world. The receptable identifier may be associated with the physical entity of the receptable. This way the virtual identifier of the receptable may be uniquely linked to the physical receptable. Such linking may include a physical link of identifiers uniquely associated with the physical respectable. For physical linking a tag or code may be physically connected to the respectable, e.g., by printing a QR code or an RFID tag or using other sensors or methods.

In another embodiment providing the receptable identifier includes generating the receptable identifier for connection to the receptable. If the receptable is not associated with the receptable identifier on recycling, the receptable identifier may be generated. This provides more flexible handling of material residues and dynamic receptable generation depending on residues incurring.

In another embodiment the material identifier element includes a machine-readable code associated with the physical material identifier and/or the receptable identifier element includes a machine-readable code associated with the receptable identifier. The machine-readable code may be a one- or two-dimensional bar code or other codes. The machine-readable code may be a code stored on a passive or active electronic tag, such as an RFID tag or using other sensors or methods.

In another embodiment a quantity of material residue, a number of receptables and/or a type of material residue is provided. The type of material residue may be provided by the material data.

The number of receptables may be provided by the number of receptable identifiers provided.

The quantity of material residue may be provided by measurement such as weighing. The recycling instructions may be generated based on or from the quantity of material residue, the number of receptables and/or the type of material residue. The quantity may relate to a mass, volume or weight of the material residue. This way the amount of material to be recycled can be tracked and taken into account on operating the recycling process. For instance, the quantities of material in one or more receptables may be tracked. The number of receptables may also be used to determine the quantity of material residue. Such quantities may be used to determine for example the total quantity of material available in different locations, the collection route for collecting the receptable at different locations, the collection time for collecting the receptables at different locations, or the expected quantity of recyclate available for material.

In another embodiment the physical material identifier is associated with material residue to be filled to one or more receptable(s) and the receptable identifier is associated with respective receptables. The physical material identifier(s) and the receptable identifier(s) signifying the receptables filled with associated material residue may be digitally linked to each other. The physical material identifier and the receptable identifier may be digitally linked. By linking the physical material identifier and the receptable identifier to each other the material residue to be recycled or recycled can be sorted and tracked via the receptable identifier. This way complex sorting can be avoided, since the sorting may be done virtually. For sorting the receptable identifiers, the linked physical material identifiers may be used to access the material data related to the physical material identifiers. In particular sorting may be conducted by way of chemical composition provided by the material data.

In another embodiment multiple physical material identifier(s) are linked to at least one receptable identifier. If more than one material type is present in the material residue, respective physical material identifier(s) may be provided and linked to the receptable identifier associated with the receptable such material residues are collected in. This way the content of a receptable can be made transparent via the physical material identifier(s) and the associated material data.

Based on the respective material data it may be determined, if the content of the receptable comprises a mix of material types or one type of material. If a mix of material types are collected per receptable, recycling instructions may be generated that include at least one sorting step.

Recycling instructions may be generated that relate to at least one sorting step followed by the recycling plant or process, such as mechanical and/or chemical recycling plant or process. If one type of material is present, recycling instructions may be generated that relate to the recycling plant or process, such as mechanical and/or chemical recycling plant or process. The recycling instructions may connect the receptables with one material type directly to the recycling plant or process. In other words, the recycling instructions may not include a sorting step preceding the recycling plant process.

In another embodiment recycling instructions may be generated for recycling via or with dedicated receptables associated with receptable identifier(s) or for recycling via or with receptables to be associated with receptable identifier(s). In case of receptable(s) associated with receptable identifier(s), the receptable identifier may be provided via the receptable identifier element. In case of receptable(s) not associated with receptable identifier(s), a receptable identifier generator may be configured to generate and provide the receptable identifier. The receptable identifier generator may be configured to output the identifier element for connection to the receptable.

In another embodiment the physical material identifier(s) and the receptable identifier(s) signifying the receptables filled with associated material residue are digitally linked to each other on providing the material, prior to usage of the material, on usage of the material, on providing the material to the location of use or after usage of the material. The receptables may be provided with the material.

In another embodiment the recycling instructions relate to a physical collection, a physical sorting and/or a physical recycling of the material residue, e.g. by a recycling process, such as mechanical and/or chemical recycling. The recycling instructions may be determined based on material data. The material data may be accessed via the material identifier(s). The recycling instructions may be determined based on chemical composition. The chemical composition may be accessed via the material identifier(s).

In another embodiment the material is a polystyrene containing material, a polystyrene-based foam material or a polystyrene-based thermal insulation or packaging material. The material residue may be from a material containing synthetic polymer(s) such polystyrene containing material, a polystyrene-based foam material or a polystyrene-based thermal insulation or packaging material.

In another embodiment the material provider interface is configured to provide access to a material passport associated with the material, wherein the material passport relates to the physical material identifier and the material data associated with the material. The material passport may comprise a decentral identifier and/or a digital representation of or linked to material data.

The digital representation may include one or more representation(s) for accessing the material data or part(s) or subset(s) thereof. The digital representation may include one or more representation(s) of material data or part(s) or subset(s) thereof. The material passport may include data related to the material data, cryptographic information such as a public key and/or the decentral identifier. The data related to the material data may include the digital representation of the material data. The digital representation(s) pointing or linking to material data or parts thereof may comprise at least one interface to a data providing service. It may further include at least one interface to a data consuming service. It may include an endpoint for data exchange or sharing (resource endpoint) or an endpoint for service interaction (service Endpoint), that is uniquely identified via a communication protocol. The digital representation(s) pointing to material data or parts thereof may be uniquely associated with the decentral identifier.

The physical material identifier and/or the receptable identifier may be a or include decentral identifier. The decentral identifier may relate to any identifier uniquely associated with the material or the receptable. The decentral identifier may include an identifier associated with the material. The decentral identifier may include more than one identifier associated with the material and/or the receptable. The decentral identifier may include any unique identifier uniquely associated with a data owner and material data associated with the material.

The decentral identifier may include a Universally Unique IDentifier (UUID) or a Digital IDentifier (DID). The decentral identifier may be issued by a central or decentral identity issuer. Via the decentral identifier and its unique association with the data owner and material data access to the material data may be controlled by the data owner. The data owner may be the producer of the material. This contrasts with central authority schemes, where identifiers are provided by the central authority and access to the data is controlled by such central authority. Decentral in this context refers to the usage of the identifier as controlled by the data owner. The decentral identifier may be connected to a digital representation of material data. The digital representation may include a representation for accessing the material data or parts thereof. The decentral identifier may be connected to authentication information and/or authorization information. The decentral identifier may comprise any unique identifier uniquely associated with the data owner and material data. The decentral identifier may include a Universally Unique IDentifier (UUID) or a Digital IDentifier (DID). The decentral identifier may be issued by a central or decentral identity issuer. The decentral identifier may include authentication information. Via the decentral identifier and its unique association with the physical entity and material data access to the material data may be controlled by the data owner, e.g. the producer of the material. This contrasts with central authority schemes, where identifiers are provided by such central authority and access to data is controlled by such central authority. Decentral in this context refers to the usage of the identifier in implementation as controlled by the data owner.

### BRIEF DESCRIPTION OF THE DRAWINGS

In the following, the present disclosure is further described with reference to the enclosed figures:

FIG. 1 illustrates schematically an example of recycling material residue from thermal insulation or packaging material.

FIG. 2 illustrates an example of an apparatus for recycling material residue from thermal insulation or packaging material.

FIG. 3 illustrates an example of a method for recycling material residue from thermal insulation or packaging material.

FIG. 4 illustrates an example of a recycling operation system for recycling material residue from thermal insulation or packaging material.

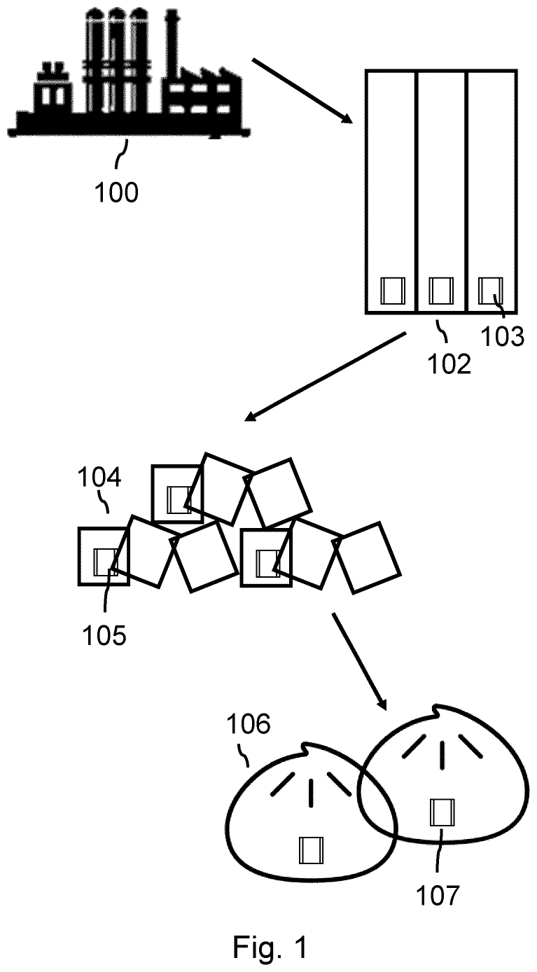

FIG. 1 illustrates schematically an example for recycling material residue from thermal insulation or packaging material. Thermal insulation or packaging material here only serves as illustrative example and shall not be considered limiting. The same principles, methods and apparatus embodiments apply to other polymeric material streams, in which material residue arises e.g. during production or use of the material.

Thermal insulation or packaging material 102 is shown as an example in FIG. 1 and may in particular include thermoplastic foam. The thermoplastic foam may be extruded or expandable foam. The extruded or expandable foam may contain a polystyrene, a copolymer produced from styrene or mixtures of polymers of this type. For example, the extruded foam may be extruded polystyrene (XPS), which by way of example is obtainable commercially as Styrodur® from BASF SE. The extruded foam may be produced via continuous extrusion of thermoplastic polymers. The fundamental steps in the process for the production of, for example, the extruded polystyrene foam (XPS) are disclosed in “Polystyrol, Kunststoffhandbuch 4” [Polystyrene, Plastics handbook 4] [H. Gausepohl and R. Gellert, Hanser-Verlag, Munich (1996)), chapter 13.2.3 (pp. 591-598). Materials based on extruded thermoplastic foam with uniform properties may be obtained by homogenizing the melt, for example by using static or dynamic mixers upstream of the die, in the extruder.

The thermal insulation or packaging material 102 may be produced in the form of thermal insulation boards or panels or packaging boards or panels 102. The production line 100 may include an extruder configured to extrude thermoplastic foam in the form of thermal insulation boards or panels or packaging material 102. During production material residues may incur, which may be recycled according to the methods disclosed herein. The material identifier may refer to the polymeric material streams provided to the extruder. Thermal insulation boards or panels 102 may be used for thermal insulation in sealings, floors, roofs and walls of buildings. Packaging materials may be used for protecting or storing goods. The produced thermal insulation and/or packaging material(s) 102 may be tagged with an identifier element 103. Single material panels 102 and/or the packaging may be tagged with the identifier element 103. Alternatively a group of multiple material panels 102 may be packed together and tagged with the identifier element 103.

The identifier element 103 may include a machine-readable code for storing the physical material identifier of the one or more thermal insulation or packaging material 102. For example, the identifier element 103 may include a printed one or two-dimensional code such as a barcode or a QR-code or other codes. The identifier element 103 may include an array of black and white squares storing at least the physical material identifier of the one or more thermal insulation or packaging material(s) 102. Further for example, the identifier element 103 may include an electronic tag such as a RFID tag for storing the physical material identifier of the one or more thermal insulation or packaging material(s) 102. The physical material identifier and any information attached to such identifier may be accessed through a code reader such as a mobile phone or other devices with camera for scanning QR codes or a RFID reader for reading out RFID tags.

The thermal insulation panel(s) 102 may be used for thermal insulation in sealings, floors, roofs and walls of buildings. On such uses the panels 102 are typically cut to fit into cavities. On cutting or trimming material residue or scrap material 104 may be produced, which may be recycled. On building sites such material may be disposed and mixed with other residues or scraps. This way the potential to recycle such residue or scrap 104 is impeded. In addition, the content of the mixed residue or scrap material is not easily known. In the operation of the recycling process the material residues may be mixed and require complex sorting. This makes recycling of material residues from materials such as thermal insulation material 102 costly and inefficient.

Packaging materials may be used for protecting or storing goods and after usage may be recycled. In the operation of the recycling process the material residue may be mixed and require complex sorting. This makes recycling of material residue from materials such as package material 102 costly and inefficient.

To support recycling e.g. on building sites, stores or construction material traders or other places and increase the recycling rate, the material residues 104 may be collected in receptables 106 intended for such purpose. Suitable receptables 106 may include bags or containers. Such receptables 106 may include an identifier element 107. The identifier element 107 of the receptable 106 may include a machine-readable code for storing the receptable identifier of the receptable 106. For example, the identifier element 107 may include a printed one or two-dimensional code such as a barcode or a QR-code or other codes. The identifier element 107 may include an array of black and white squares storing at least the receptable identifier of the receptable 106. Further for example, the identifier element 107 may include an electronic tag such as a RFID tag for storing the receptable identifier of the receptable 107. The receptable identifier and any information attached to such identifier may be accessed through a code reader such as a mobile phone or other devices with camera for scanning QR codes or a RFID reader for reading out RFID tags. The receptable(s) may be provided together with the material for collecting material residues or scrapes. The receptable identifier may be linked to the material identifier associated with the material the receptable is provided with. This way collection receptables may be provided together with the materials to collect material scrape and to simplify recycling.

To provide a more reliable and efficient recycling process, the apparatuses and methods for recycling material residues 104 via receptables 106 is proposed.

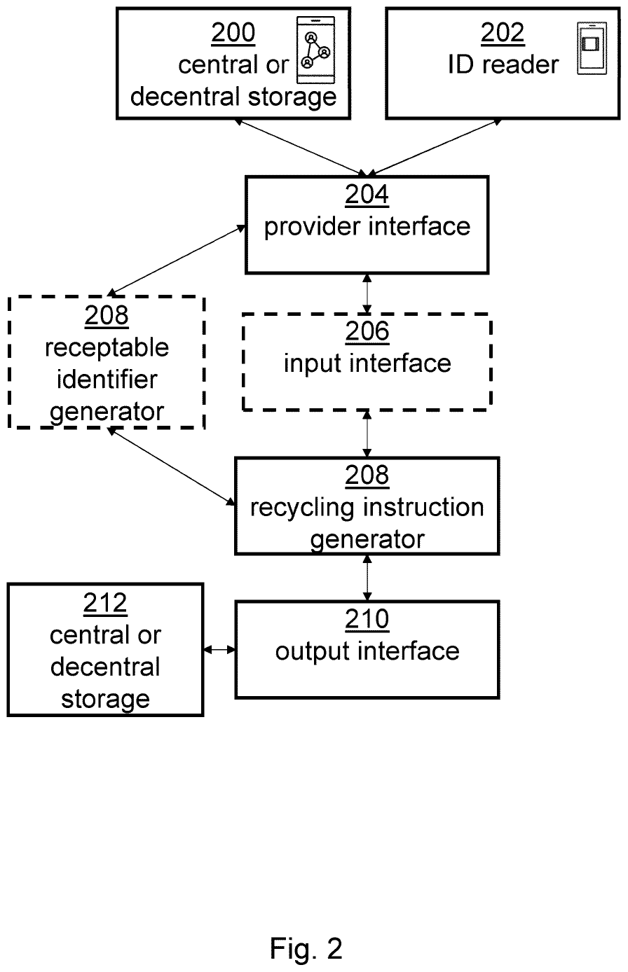

FIG. 2 illustrates an example of an apparatus for recycling material residue 104 from e.g. thermal insulation material or packaging material. As in the context of FIG. 1, thermal insulation or packaging material are used by way of examples for material containing one or more synthetic polymer(s).

The apparatus may include a provider interface 204 configured to provide a physical material identifier and material data associated with the material e.g. with the thermal insulation or packaging material. The provider interface 202, e.g. a material provider interface, may be configured to access a material passport associated with the material e.g. with the thermal insulation or packaging material. The material passport may be stored in computing system including a central or decentral network storage 200. The material passport may provide access to the material data of the material, such as the thermal insulation or packaging material as produced, via the physical material identifier of the material, such as the thermal insulation or packaging material as produced. For example, the identifier element connected to the material such as the thermal insulation or packaging material after production may be read out to provide the physical material identifier. The physical material identifier of the material, such as the thermal insulation or packaging material, may be provided by an ID reader 202. The physical material identifier associated with the material, such as the thermal insulation or packaging material, may have been provided to a computing system 200 accessing a central or decentral data base storing the material passport. The data base may store the physical material identifier in connection with material data provided by the producer of the material, such as the thermal insulation or packaging material, on production of the material, such as the thermal insulation or packaging material.

The data base may be a central, decentral or distributed data base. Based on the physical material identifier the material data may be accessed or retrieved. Such material data may be output e.g. on a display to a user.

Material data may include the trade name of the material, such as the thermal insulation or packaging material, the chemical composition of the material, such as the thermal insulation or packaging material, and/or manufacturing data of the material, such as such as manufacturer, manufacturing method or educts used for manufacturing.

The provider interface 204, e.g. a receptable provider interface, may be configured to provide a receptable identifier associated with a receptable for collecting the material residue. For example, an identifier element 107 connected to the receptable 106 for collecting the material residue may be read out. The receptable identifier associated with the receptable may be provided. The receptable identifier associated with the receptable may be provided to the computing system including the central or decentral network 200 for linking with the physical material identifier(s) associated with material residue 104 filled into the receptable 106.

To identify the material residue 104 collected inside the receptable 106 on collection, the receptable identifier and the physical material identifier of the material, such as the thermal insulation or packaging material, from which the material residue is formed may be provided. The receptable identifier may be stored in connection with or linked to the physical material identifier of the material, such as the thermal insulation or packaging material. The receptable(s) may be provided together with the material for collecting material residues or scrapes. The receptable identifier may be linked to the material identifier associated with the material the receptable is provided with the material or on providing the material. This way collection receptables may be provided together with the materials to collect material scrape and to simplify recycling. Based on such connection or link the material data of the material residue, such as the insulation or packaging material residue 104 may be accessed or retrieved. The material data may be provided via the material passport of the material, such as the thermal insulation or packaging material, as provided on production of the material, such as the thermal insulation or packaging material. This way the material, such as the thermal insulation or packaging material, can be reliably tracked and made transparent to simplify the recycling process.

The apparatus may include an input interface 206 configured to receive a request for recycling of the material residue e.g. by a user of the material or a recycler of the material residue. The input interface may be configured to receive a request for recycling of material, such as thermal insulation or packaging material. The request may include recycling data associated with the material residue 104, such as thermal insulation or packaging material residue. The recycling data may include a trigger signal to initiate the recycling process.

The apparatus may include a recycling instruction generator 208 configured to generate recycling instruction(s) based on the receptable identifier and the material identifier. The material identifier and the receptable identifier may be provided through an ID reader 202 prior or on collection of material residue 104 in the receptable 106. For example, the material identifier and the receptable identifier may be provided by reading a QR-code via a mobile phone or other devices. The material identifier and the receptable identifier may be linked on collection e.g. by generating a virtual link between the material identifier and the receptable identifier and/or storing such link in the central or decentral network storage. Since the material residue may contain multiple materials, more than one physical material identifier may be provided. Multiple physical material identifier(s) may be linked to one receptable identifier. By linking the receptable identifier with the physical material identifier(s) associated with the material residue collected inside the receptable, the content of the receptable can be made digitally accessible and transparent.

Based on the respective material data it may be determined, if the content of the receptable comprises a mix of material types or one type of material. If a mix of material types are collected per receptable, recycling instructions may be generated that include at least one sorting step.

The recycling instructions may connect the receptables with multiple material types to a sorting process followed by the recycling process, such as mechanical and/or chemical recycling. If on type of material is present, recycling instructions may be generated that relate to the recycling process, such as mechanical and/or chemical recycling. The recycling instructions may connect the receptables with one material type directly to the recycling process, such as mechanical and/or chemical recycling. In other words, the recycling instructions may not include a sorting step preceding the recycling process, such as mechanical and/or chemical recycling.

The recycling instruction generator may be configured to provide e.g. the user with different options for recycling such as recycling via dedicated receptables associated with receptable identifier(s) or recycling via receptables not associated with receptable identifier(s).

In case of receptable(s) associated with receptable identifier(s), the recycling instruction generator or the input interface may be configured to prompt a user to provide the receptable identifier.

The input interface may be configured to receive a request for providing the receptable identifier. The receptable identifier may be provided via the provider interface and/or the ID reader.

The receptable identifier may be stored in connection with or linked to the physical material identifier of the material, such as thermal insulation or packaging material.

In case of receptable(s) not associated with receptable identifier(s), the recycling instruction generator or the input interface may be configured to prompt a user to generate the receptable identifier. A receptable identifier generator 108 may be configured to generate and provide the receptable identifier. The receptable identifier generator may be configured to output the identifier element 105 for connection or physical attachment to the receptable 104. The receptable identifier may be stored in connection with or linked to the physical material identifier of the material, such as thermal insulation or packaging material.

The recycling instruction(s) may relate to the physical collection, the physical sorting and/or the physical recycling of the material residue. For example, the recycling instructions may correlate the location of the material residue, such as thermal insulation or packaging material residue, with locations of other thermal insulation or packaging material residue. From such locations a collection route may be determined, and collection instructions for collecting the material residue may be determined. Further for example, the recycling instructions may correlate the chemical composition of the material, such as thermal insulation or packaging material residue, with chemical compositions of other material, such as thermal insulation or packaging material residue. This way a simplified sorting through the identifiers associated with the receptables is possible and more complex sorting can be avoided. Based on the chemical composition and/or the locations the collection instruction(s) may be determined. Using the chemical composition, the receptable collection may be operated according to chemical composition, such that material residue with chemical composition that can be recycled together or fed into a recycling plant together may be collected. This allows for sorting of receptables on collection or sorted collection and avoids more complex sorting prior to recycling. In addition, based on the chemical composition and respective sorting higher quality recyclate can be achieved on recycling in recycling plants. The connection of recycling data associated with the material residue, such as thermal insulation or packaging material residue, and the material data associated with the produced material, such as thermal insulation or packaging material allows for more efficient recycling and increases recyclate quality, since waste stream can be managed in a controlled manner. This simplifies the production of new materials, since more complex cleaning or separation of the recyclate stream can be avoided.

The provider interface 204, e.g. the receptable provider interface or any other suitable interface, may be configured to provide a quantity of material residue, such as thermal insulation or packaging material residue, e.g. mass, weight or volume, a type of material residue, a number of receptables, a location of material residue, a user of the material residue, and/or a manufacturer of the material residue. The data may be provided by a user, the ID reader, the computing system including a central or decentral network storage and/or through the provider interface accessing the material passport of the material.

The apparatus may include an output interface 210 configured to provide the generated recycling instructions for recycling the material residue, such as thermal insulation material residue.

The recycling instructions may be provided to a central or decentral network 212. The recycling instructions may be provided for access or retrieval by a collector for collecting the material residue, a recycler for recycling the material residue and/or a manufacturer for manufacturing new materials from the material residue.

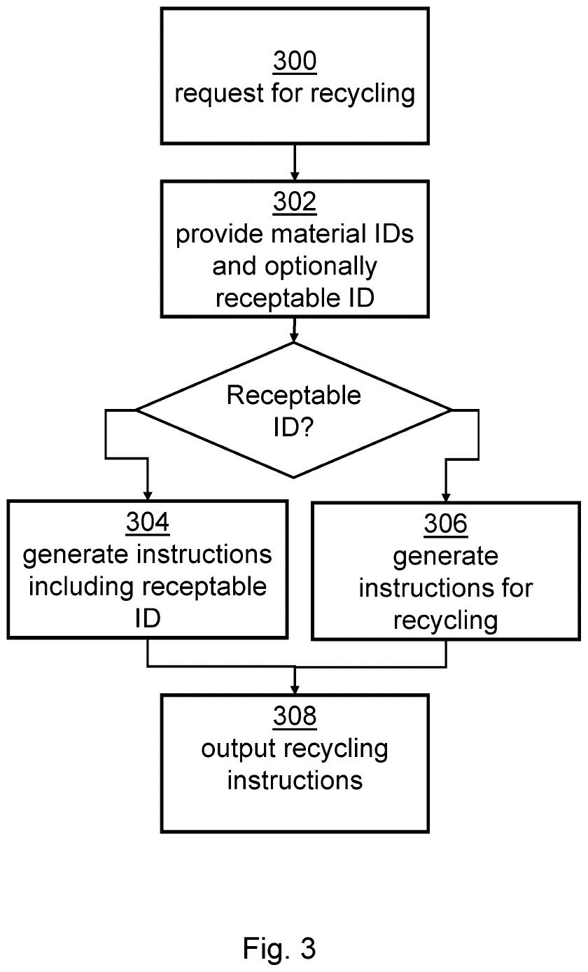

FIG. 3 illustrates an example of a method for recycling material residue from thermal insulation or packaging material. As in the context of FIGS. 1 and 2, thermal insulation or packaging material are used by way of examples for material containing one or more synthetic polymer(s).

A request for recycling of the material residue may be received. The request may include recycling data associated with the thermal insulation or packaging material residue. The recycling data may include the trigger signal to initiate the recycling process, the quantity of thermal insulation or packaging material residue, such as mass, weight or volume, the type of thermal insulation or packaging material residue, the location of the thermal insulation or packaging material residue and/or the manufacturer of the thermal insulation or packaging material residue.

A physical material identifier and material data associated with the material may be provided. A material passport associated with the thermal insulation or packaging material may be accessed. The material passport may relate to the physical material identifier and material data.

For example, the identifier element 103 connected to the thermal insulation or packaging material 102 may be read out. The physical material identifier associated with the thermal insulation or packaging material 102 may be provided to a computing system accessing a central or decentral storage storing the material passport. The storage may store the physical material identifier in connection with material data provided by the producer of the thermal insulation or packaging material 102. The storage may be a central, decentral or distributed storage. Based on the physical material identifier the material data may be accessed or retrieved. Such material data may be output e.g. on a display to a user.

Material data may include the trade name of the thermal insulation or packaging material, chemical composition of the thermal insulation or packaging material, technical properties of the thermal insulation or packaging material, application related properties of the insulation or packaging material, and/or application instructions. Technical properties may include thermal properties like thermal expansion, thermal conductivity or thermal resistance, geometric properties like length, width or texture, compression properties like compression strength, compression stress or permissible compression stress, modulus of elasticity, dimensional stability, deformation behavior, water vapor diffusion resistance factor, water absorption properties, temperature limits, pressure resistance, tensile strength, stiffness, acoustic properties, noise properties, deformation properties. Application related properties may include technical specification for one or more area(s) of application such as roof, ceiling, floor or base. Application instructions may include installation instructions for one or more area(s) of application such as roof, ceiling, floor or base. Application data may include application related properties and/or application related instructions.

A receptable identifier associated with a receptable 106 for collecting the material residue may be provided. For example, an identifier element 105 connected to the receptable 106 for the insulation or packaging material residue may be read out. The receptable identifier associated with the insulation or packaging material residue may be provided to the central or decentral storage. The receptable identifier may be stored in connection with or linked to the physical material identifier of the thermal insulation or packaging material 102. Based on such connection or link the material data of the insulation material residue may be accessed or retrieved.

Recycling instruction(s) based on the receptable identifier and the material data or the material identifier may be generated. The material identifier and the receptable identifier may be linked.

Since the material residue may contain multiple materials, more than one material identifier may be provided. Multiple material identifier(s) may be linked to one receptable identifier.

The user may be provided with different options for recycling such as recycling via dedicated receptables associated with identifier or recycling via receptables not associated with identifier.

In case of receptables associated with identifier, the user may be prompted to provide the receptable identifier. A request for providing the receptable identifier may be received. The receptable identifier may be provided via the provider interface. The receptable identifier may be stored in connection with or linked to the physical material identifier of the thermal insulation or packaging material.

In case of receptables not associated with identifier, the user may be prompted to generate the receptable identifier. The receptable identifier associated with the identification element of the receptable may be provided. The identifier element for connection to the receptable may be output. The receptable identifier may be stored in connection with or linked to the physical material identifier of the thermal insulation or packaging material.

The recycling instruction(s) may relate to the physical collection, the physical sorting and/or the physical recycling of the thermal insulation or packaging material residue. For example, the recycling instructions may correlate the location of the thermal insulation or packaging material residue with locations of other thermal insulation or packaging material residue. From such locations a collection route may be determined, and collection instructions may be determined. Further for example, the recycling instructions may correlate the chemical composition of the thermal insulation or packaging material residue with chemical compositions of other thermal insulation or packaging material residue. This way a simplified sorting through the identifiers associated with the receptables is possible and more complex sorting machinery can be avoided. Based on the chemical composition and the locations the collection instruction(s) may be determined.

Using the chemical composition, the receptable collection may be operated according to chemical composition. This allows for sorting of receptables on collection or sorted collection and avoid more complex sorting prior to recycling. In addition, based on the chemical composition and respective sorting higher quality recyclate can be achieved on recycling. The connection of recycling data associated with the thermal insulation or packaging material residue and the material data associated with the produced thermal insulation or packaging material allows for more efficient recycling and increases recyclate quality, since waste stream can be managed in a controlled manner. This simplifies the production of new materials, since more complex cleaning or separation of the recyclate stream can be avoided.

The generated recycling instructions for recycling the thermal insulation or packaging material residue may be provided. The recycling instructions may be provided for access by a collector for collecting the thermal or packaging scrap material, a recycler for recycling the thermal or packaging material residue or a manufacturer for manufacturing new materials from the thermal or packaging material residue.

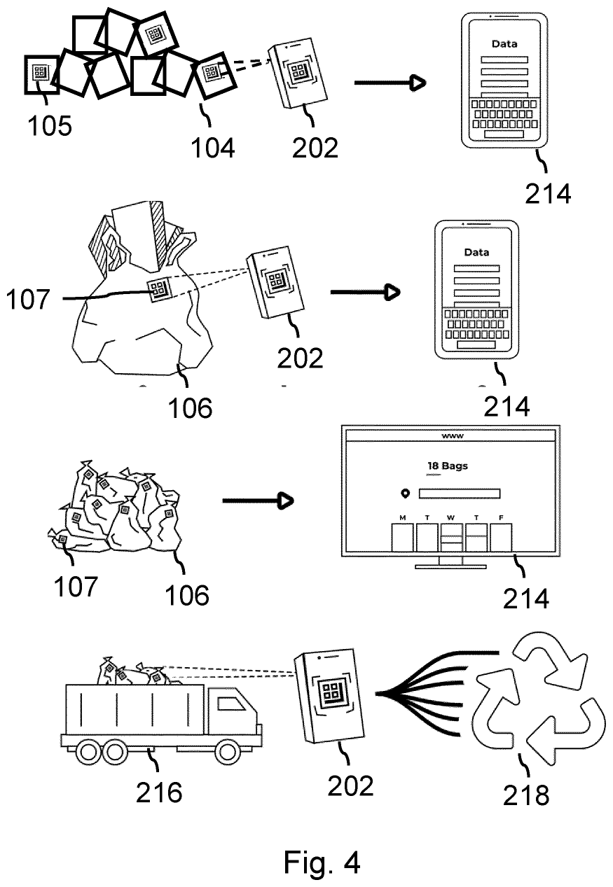

FIG. 4 illustrates an example of a recycling process for material residue from thermal insulation or packaging material. As in the context of FIGS. 1, 2 and 3, thermal insulation or packaging material are used by way of examples for material containing one or more synthetic polymer(s).

The recycling process illustrated in the example of FIG. 4 includes the steps of filling the material residue into receptables, collecting the filled receptables and providing the filled receptables to a recycling plant. To simplify the recycling process the apparatus as for instance described in the context of FIG. 2 or the method as described for instance in the context of FIG. 3 may be employed or used.

Tracking the content of receptables with material residue is particularly challenging, since material residues are not connected to the material and its identifier elements anymore. This means the material data for the material residue is not easily accessible once the residue is collected in the receptable. While the identifier element of the material is intact, the material data may be accessed via the physical material identifier(s). The material data may hence be accessed or provided prior to use of the material leading to the material residue or after use of the material leading to the material residue, e.g. if the identifier element was attached to the packaging of the material and is still intact. In addition, the receptable identifier(s) may be provided that is associated with the receptable(s) to be filled with the material residue stemming from the material the material data is provided for. This way the material data may be used to specify the material residue content of the receptable.

The recycling instructions generated based on the receptable identifier and the material data may be physical filling instructions for the receptable. For example, the user is prompted to read material IDs and the receptable IDs prior to use of the material, filling of the receptable and/or collection of the filled receptables. After using the thermal insulation or packaging material, material residue may arise. Such material, packaging of such material or packaging material may include one or more identifier element(s) 105 providing the physical material identifier(s) as provided on production of the thermal insulation or packaging material from which the material residue is formed. On recycling such identifier element(s) 105 may be read via the ID reader 202 such as a mobile phone or other devices with camera configured to read QR-codes or other codes. In some embodiment the identifier element(s) 105 may be read prior to usage of the thermal insulation or packaging material. In other embodiments the identifier element(s) 105 may be provided or read on usage of the thermal insulation or packaging material. In yet other embodiments the identifier element(s) 105 may be read on providing the thermal insulation or packaging material to the location of use. The physical material identifier(s) may thus be provided that are associated with the material to be used and may be stored. The material data may be accessed through or via the physical material identifier(s). The material data may be stored.

The material data associated with the physical material identifier(s) may be displayed on a screen 214, e.g. of the reader 202.

Receptable(s) 106 for collecting material residue may include the receptable identifier element(s) 107. The receptable identifier element(s) 105 may be read via the ID reader 202 such as a mobile phone or other devices with camera configured to read QR-codes or other codes.

Any receptable data associated with the receptable identifier(s) may be displayed on a screen 214, e.g. of the reader 202. In particular, the receptable identifier(s) may be linked or connected to the physical material identifier(s) collected in such receptables. To do so recycling instruction for filling material residue into receptables may be generated and provided to the user. The user may be instructed via the screen 214 to scan the identifier element(s) connected to the material that residue is to be collected from. Such scan may by instructed prior to usage of the material, on usage of the material, on providing the material to the location of use or after usage of the material, e.g. if the identifier element was attached to the packaging of the material and is still intact. Further the user may be instructed via the screen 214 to scan the identifier element(s) connected to the receptables such material residue is to be collected in.

The material data may be stored in connection with the receptable(s). This way the physical material identifiers and the receptable identifiers can be linked reflecting the physical relationship between receptables and material residue collected in such receptables. The linking may include a link between multiple physical material identifiers and one receptable identifier, a link between multiple physical material identifiers and multiple receptable identifiers or a link between one physical material identifier and multiple receptable identifiers. In particular such linking allows to access the material data provided on production of the material by the material producer, which simplifies the recycling process through identification of the material to be recycled per receptable.

The receptables filled with material residue in the above lined out manner can be collected and the material residue can be provided to the recycling plant in a controlled manner. To do so further recycling instructions for collecting the filled receptables and providing the filled receptables to a recycling plant may be generated and provided to the user. For instance, the pick-up of the receptables may be scheduled based on the number of receptables 106 filled. The filled receptables may be collected and transported to the recycling plant. Prior to entering the recycling plant the receptables'content may be determined by reading the identifier element(s) to provide the receptable identities and to access the data linked to the receptable identities such as the material data. The recycling instructions may be physical collection and/or sorting instructions related to the filled receptables depending on the material type(s) included per receptable. For example, if one material type is included sorting may be skipped and the receptables with one material type may be collected together and provided to the recycling process. Further for example, if multiple material types are included, the receptables with multiple material types may be collected together and provided for sorting prior to being provided to the recycling process.

The recycling instructions may be physical recycling instructions. The collected receptables with one material type may be provided to the recycling plant directly without sorting in the preceding step. The collected receptables with multiple material types may be provided to the sorting step prior to being provided to the recycling process.

By using the recycling process lined out above, the recycling of material can be conducted more efficiently. In particular the transparency to material data across different stages of the material life cycle allows for more cost-effective recycling, higher recyclate quality and more control over material flows when material residue is involved. Overall this enables higher recycling rates and reduced the environmental impact of materials in particular when material residue is involved.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa. All terms used herein are understood broadly and have their general meaning.

1.-15. (canceled)

16. A method for recycling of material residue from a material containing one or more synthetic polymer(s), the method comprising:
providing one or more physical material identifier(s) and material data associated with the material containing synthetic polymer(s);
providing one or more receptable identifier(s) associated with receptable(s) for collecting the material residue from the material containing synthetic polymer(s);
generating one or more recycling instruction(s) based on the one or more receptable identifier(s) and the material data; and
providing the generated recycling instruction(s) for recycling of the material residue.

17. The method according to claim 16, wherein the material data is associated with the material the material residue is produced from, wherein material data is accessed or accessible via the one or more physical material identifier(s) associated with the material.

18. The method according to claim 16, wherein the material data associated with the one or more physical material identifier(s) are provided by a producer of the material.

19. The method according to claim 16, wherein the one or more physical material identifier(s) are provided by a material identifier element connected to the material, wherein at least the physical material identifier is encoded to the material identifier element, wherein the material identifier element is physically connected to the material, wherein the physical material identifier is uniquely associated with the physical entity of the material.

20. The method according to claim 16, wherein material data is used to generate the recycling instructions that relate to a physical filling of receptables with material residue, a physical collection of filled receptables, a physical sorting of filled receptables or a physical recycling of the material residue provided by a recycling plant.

21. The method according to claim 16, wherein the material residue includes residues resulting during production of the material containing the at least one synthetic polymer, residues resulting from the use of said material or residues resulting from the use of a component produced based on said material.

22. The method according to claim 16, wherein the one or more receptable identifier(s) are provided by a receptable identifier element connected to the receptable, wherein at least the receptable identifier is encoded to the receptable identifier element, wherein the identifier element is physically connected to the receptable.

23. The method according to claim 16, wherein a quantity of material residue, a number of receptables or a type of material residue is provided, wherein recycling instruction(s) are generated from the quantity of material residue, the number of receptables or the type of material residue.

24. The method according to claim 16, wherein the one or more physical material identifier(s) are associated with material residue to be filled to the one or more receptable(s) and the receptable identifier(s) are associated with respective receptable(s).

25. The method according to claim 16, wherein the physical material identifier(s) and the receptable identifier(s) signifying the receptables filled with associated material residue are digitally linked to each other.

26. The method according to claim 16, wherein multiple physical material identifier(s) are linked to at least one receptable identifier.

27. The method according to claim 16, wherein the physical material identifier(s) and the receptable identifier(s) signifying the receptables filled with associated material residue are digitally linked to each other on providing the material, prior to usage of the material, on usage of the material, on providing the material to the location of use or after usage of the material.

28. An apparatus for recycling of material residue from a material containing one or more synthetic polymer(s), wherein the apparatus comprises:
a material provider interface configured to provide one or more physical material identifier(s) and material data associated with the material containing synthetic polymer(s);
a receptable provider interface configured to provide one or more receptable identifier(s) associated with receptable(s) for collecting material residue from the material containing synthetic polymer(s);
a recycling instruction generator configured to generate one or more recycling instruction(s) based on the one or more receptable identifier(s) and the material data; and
an output interface configured to provide the generated recycling instruction(s) for recycling of the material residue.

29. A computer-readable medium or a computer program with instructions, which when executed on a processor, perform the steps of any of the methods of claim 16.

30. A method for recycling a material residue from material containing one or more polymer(s), the method comprising:
using the recycling instructions generated according to claim 16.
